(19) United States
(12) Patent Application Publication
(10) Pub. No.: US 2025/0184470 A1
(43) Pub. Date: Jun. 5, 2025

(54) THREE-DIMENSIONAL DISPLAY DEVICE

(71) Applicant: EXCELLENCE OPTO., INC., Miaoli County (TW)

(72) Inventors: KUO-HSIN HUANG, Miaoli County (TW); FU-BANG CHEN, Miaoli County (TW)

(21) Appl. No.: 18/811,545

(22) Filed: Aug. 21, 2024

(30) Foreign Application Priority Data
Dec. 4, 2023 (TW) 112147055

(51) Int. Cl. H04N 13/395

(52) U.S. Cl. CPC H04N 13/395

(57) ABSTRACT

A three-dimensional display device includes a three-dimensional display assembly. The three-dimensional display assembly includes a first display panel, a second display panel and a transparent display panel. The first display panel has a first display surface. The second display panel is connected to one side of the first display panel and has a second display surface. There is an included angle between the second display surface and the first display surface. The transparent display panel, the first display panel and the second display panel form a triangular prism, and the first display surface and the second display surface face the transparent display panel.

### CROSS-REFERENCE TO RELATED APPLICATIONS

This application claims the benefit of Taiwanese Application No. 112147055, filed on Dec. 4, 2023, which is hereby incorporated by reference for all purposes as if fully set forth herein.

### FIELD OF THE INVENTION

The present invention relates to a display device, and particularly relates to a three-dimensional display device.

### BACKGROUND OF THE INVENTION

A three-dimensional image is more beneficial to making audience be integrated into films compared with a two-dimensional image. Therefore, a three-dimensional display device has been widely applied to entertainment venues such as a cinema. Besides the above recreational purposes, the three-dimensional display device can further be used in the building field to assist building design through three-dimensional images. In addition, the three-dimensional display device can also be used in the medical field, so as to assist medical workers to judge internal disease of a patient. A part of three-dimensional display devices are glasses-free three-dimensional display devices in the prior art, i.e., the audience can watch three-dimensional images shown by the three-dimensional display devices directly with naked eyes. For example, referring to FIG. 1, an included angle type three-dimensional display device D is formed by splicing two-dimensional display devices D1 and D2, and the two-dimensional display devices D1 and D2 are able to generate a three-dimensional image I′ together. Although the three-dimensional image I′ generated by the included angle type three-dimensional display device D can be watched with naked eyes, a splicing beam M′ between the two-dimensional display devices D1 and D2 easily affects the visual experience, and the visual angle of the three-dimensional image I′is considerably restricted.

On the other hand, a part of glasses-free three-dimensional display devices use one two-dimensional display device, and the two-dimensional display device can be configured with an optical assembly, so as to form a three-dimensional image. For example, the three-dimensional display device mainly includes a lenticular lens three-dimensional display device and a parallax barrier three-dimensional display device according to different types of the optical assemblies. However, the three-dimensional image generated by the three-dimensional display device is prone to deformation, thereby affecting the visual experience.

In addition, the other part of three-dimensional display devices are matched with polarized glasses to form the three-dimensional image in the prior art. However, compared with the glasses-free three-dimensional display device, the audience wearing the polarized glasses is easy to feel uncomfortable, so that the visual experience is affected.

Incidentally, all the above three-dimensional display devices are non-transparent display devices, and there are transparent display devices in the prior art. Because the transparent display devices are able to represent images and backgrounds behind the images, the transparent display devices are quite suitable for trade shows.

### SUMMARY OF THE INVENTION

The present invention provides a three-dimensional display device, so as to provide a naked vision function and enhance the visual experience.

To achieve one, a part or all of the objects or other objects, the three-dimensional display device provided by the present invention includes at least one three-dimensional display assembly. Each the three-dimensional display assembly includes a first display panel, a second display panel and a transparent display panel. The first display panel has a first display surface. The second display panel is connected to a side of the first display panel, and the second display panel has a second display surface. An included angle is between the second display surface and the first display surface. The transparent display panel, the first display panel and the second display panel form a triangular prism, and the first display surface and the second display surface face to the transparent display panel.

In an embodiment of the present invention, the included angle is, for example, between 75° and 150°.

In an embodiment of the present invention, the included angle may be between 90° and 120°.

In an embodiment of the present invention, the three-dimensional display device can further include a central display panel. The central display panel has a top surface and a bottom surface opposite to the top surface, and the central display panel further has a first side surface and a second side surface opposite to the first side surface, wherein the first side surface and the second side surface are connected to and between the top surface and the bottom surface. The three-dimensional display assembly includes a first three-dimensional display assembly and a second three-dimensional display assembly, and a first display panel of the first three-dimensional display assembly and a first display panel of the second three-dimensional display assembly are respectively connected to the first side surface and the second side surface.

In an embodiment of the present invention, a width of the central display panel is D1 in a width direction pointed to the second side surface from the first side surface. A reference plane is parallel to a display surface of the central display panel, and a total width of an orthogonal projection of the first three-dimensional display assembly and the second three-dimensional display assembly on the reference plane in the width direction is D2. D2 accounts for 8% to 25% of D1.

In an embodiment of the present invention, the three-dimensional display device may further include a third three-dimensional display assembly. The first display panel of the third three-dimensional display assembly is connected to the top surface or the bottom surface.

In an embodiment of the present invention, a height of the central display panel is D3 in a height direction pointed to the bottom surface from the top surface. The reference plane is parallel to the display surface of the central display panel, a height of an orthogonal projection of the third three-dimensional display assembly on the reference plane in the height direction is D4. D4 accounts for 5% to 15% of D3.

In an embodiment of the present invention, the central display device is, for example, a small pitch light-emitting diode display panel.

In an embodiment of the present invention, the first display panel and the second display panel are, for example, sub-millimeter light-emitting diode display panels. The transparent display panel can be a small pitch light-emitting diode display panel, a micro light-emitting diode display panel, an organic light-emitting diode display panel or a liquid crystal display panel.

The three-dimensional display device provided by the present invention uses the first display panel and the second display panel spliced with each other, and the three-dimensional display device is further configured with the transparent display panel to shield the splicing beam between the first display panel and the second display panel. In detail, there is an included angle between the first display panel and the second display panel, so that the first display panel and the second display panel are able to generate a three-dimensional image as a main picture. In addition, the transparent display panel can generate an auxiliary picture to enhance the representation effect of the three-dimensional image, and the transparent display panel also can reduce the visual interference of the splicing beam to the audience by virtue of a secondary optical theory (such as refraction). Therefore, the three-dimensional display device of the present invention is able to provide a naked vision function and further has the following advantages of (1) improving the depth of field and a three-dimensional effect; (2) reducing the visual interference of the splicing beam to the audience; and (3) additionally representing subtitles or other auxiliary information by the transparent display panel. Based on above, the three-dimensional display device provided by the present invention can effectively improve the visual experience.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The present invention will become more readily apparent to those ordinarily skilled in the art after reviewing the following detailed description and accompanying drawings, in which:

FIG. 1 is a three-dimensional schematic diagram of an included angle type three-dimensional display device in the prior art;

FIG. 2 is a three-dimensional schematic diagram of a three-dimensional display device in an embodiment of the present invention;

FIG. 3 is a top view schematic diagram of the three-dimensional display device in FIG. 2;

FIG. 4 is a top view schematic diagram of a three-dimensional display device in another embodiment of the present invention;

FIG. 5 is a top view schematic diagram of a three-dimensional display device in another embodiment of the present invention;

FIG. 6 is a three-dimensional schematic diagram of the three-dimensional display device in FIG. 5;

FIG. 7 is a three-dimensional schematic diagram of the three-dimensional display device in another embodiment of the present invention; and

FIG. 8 is a side view schematic diagram of a central display panel and a three-dimensional display assembly connected to a top surface in FIG. 7.

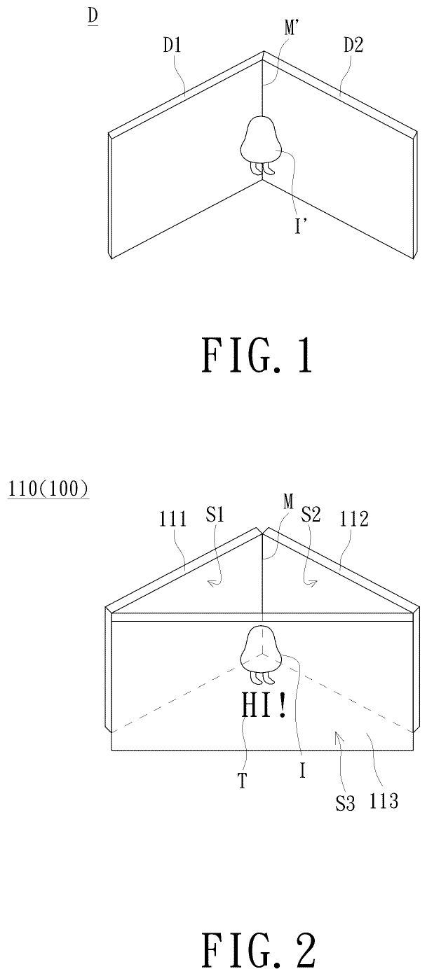

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

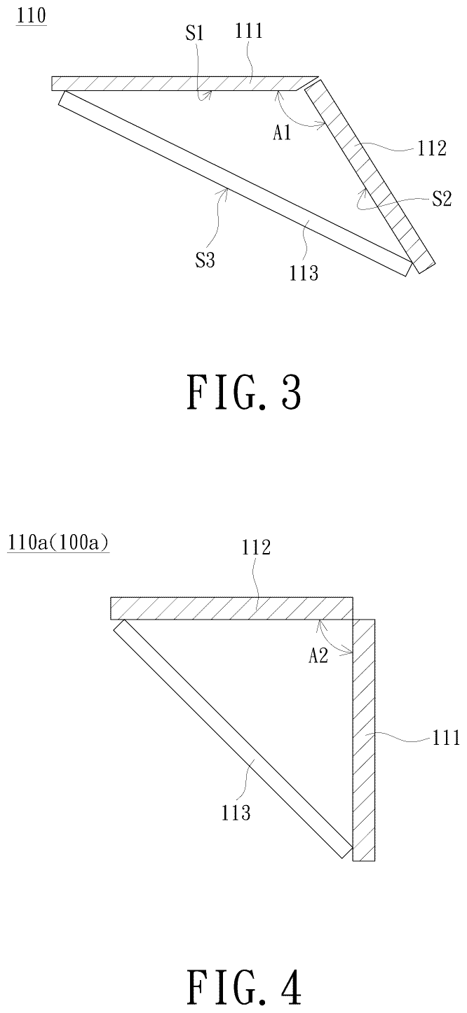

FIG. 2 is a three-dimensional schematic diagram of a three-dimensional display device in an embodiment of the present invention. FIG. 3 is a top view schematic diagram of the three-dimensional display device in FIG. 2. A three-dimensional display device 100 includes at least one three-dimensional display assembly 110, and a three-dimensional display assembly 110 is taken as an example in the embodiment. The three-dimensional display assembly 110 includes a first display panel 111, a second display panel 112 and a transparent display panel 113. The first display panel 111 has a first display surface S1. The second display panel 112 is connected to a side of the first display panel 111, and the second display panel 112 has a second display surface S2. An included angle A1 (marked in FIG. 3) is between the second display surface S2 and the first display surface S1. The transparent display panel 113, the first display panel 111 and the second display panel 112 form a triangular prism, and the first display surface S1 and the second display surface S2 face to the transparent display panel 113.

The first display panel 111 and the second display panel 112 are able to respectively generate images, and the images can form a three-dimensional image I (drawn in FIG. 2) between among the first display surface S1, the second display surface S2 and the transparent display panel 113. Thus, an audience can watch the three-dimensional image I through the transparent display panel 113. For example, the transparent display panel 113 has an transparent surface S3, and the transparent surface S3 faces away from the first display surface S1 and the second display surface S2. The audience can face the transparent surface S3 to watch the three-dimensional image I, but a watched angle of the three-dimensional image I is not limited by the present invention. The first display panel 111 and the second display panel 112 are, for example, small pitch light-emitting diode display panels in the embodiment. In detail, unit pixels of the small pitch light-emitting diode display panels are constructed by red, green and blue light-emitting diode chips (LED chip), and the pitch between two adjacent unit pixels is, for example, from 2.0 mm to 0.5 mm. Because the light-emitting diode made by the light-emitting diode chips has a high lighting effect and a preferable color purity, the first display panel 111 and the second display panel 112 combined by the light-emitting diodes have a preferable three-dimensional visual effect. In addition, because there is a small pitch between the two adjacent unit pixels, the resolutions of the first display surface S1 and the second display surface S2 can be improved, thereby further improving the visual experience. The small pitch light-emitting diode display panel includes, for example, a sub-millimeter light-emitting diode (Mini LED) display panel. However, the types of the first display panel 111 and the second display panel 112 are not limited by the present invention. The included angle A1 in the embodiment is, for example, between 75° and 150°, and the included angle A1 in FIG. 3 is about 120° taken as an example, but other embodiments are not limited thereto. In an embodiment, such as a three-dimensional display device 100a shown in FIG. 4, the included angle A2 of the three-dimensional display assembly 110a may be between 90° and 120°, and the included angle A2 in FIG. 4 is about 90° taken as an example.

Referring to FIG. 2 again, the splicing beam M (drawn in FIG. 2) is shield by the transparent display panel 113 from the watched angle of the three-dimensional display device 100 in the embodiment. Thus, the visual interference of the splicing beam M to the audience can be reduced by the transparent display panel 113 through a secondary optical theory (such as refraction). In addition, the transparent display panel 113 is able to generate an image, and the representation effect of the three-dimensional image I can be further enhanced through the image. Therefore, not only the visual effect provided by the three-dimensional display assembly 110 can be improved, but also the audience can be easier to focus on watching the three-dimensional image I, thereby further reducing the visual interference of the splicing beam M to the audience. For example, the transparent display panel 113 is able to generate auxiliary information of the three-dimensional image I, and a subtitle T is taken as an example in the embodiment. In an embodiment, the image generated by the transparent display panel 113 can further enhance the representation effect of the three-dimensional image I. The transparent display panel 113 can be a small pitch light-emitting diode display panel, a micro light-emitting diode (Micro LED) display panel, an organic light-emitting diode (OLED) display panel or a liquid crystal display panel in the embodiment. For example, the small pitch light-emitting diode display panel may include, for example, a sub-millimeter light-emitting diode display panel. However, the present invention is not limited thereto.

Compared with the prior art, the three-dimensional display device 100 in the embodiment uses the first display panel 111 and the second display panel 112 spliced with each other, and the three-dimensional display device 100 is further configured with the transparent display panel 113 to shield the splicing beam M between the first display panel 111 and the second display panel 112. In detail, there is an included angle A1 between the first display panel 111 and the second display panel 112, so that the first display panel 111 and the second display panel 112 are able to generate a three-dimensional image I as a main picture. In addition, the transparent display panel 113 can generate an auxiliary picture to enhance the representation effect of the three-dimensional image I, and the transparent display panel 113 also can reduce the visual interference of the splicing beam to the audience by the secondary optical theory. Therefore, the three-dimensional display device 100 in the embodiment is able to provide a naked vision function, and further has the following advantages of (1) improving the depth of field and a three-dimensional effect; (2) reducing the visual interference of the splicing beam M to the audience; and (3) additionally representing subtitles T or other auxiliary information by the transparent display panel 113. Based on above, the three-dimensional display device 100 in the embodiment can effectively improve the visual experience.

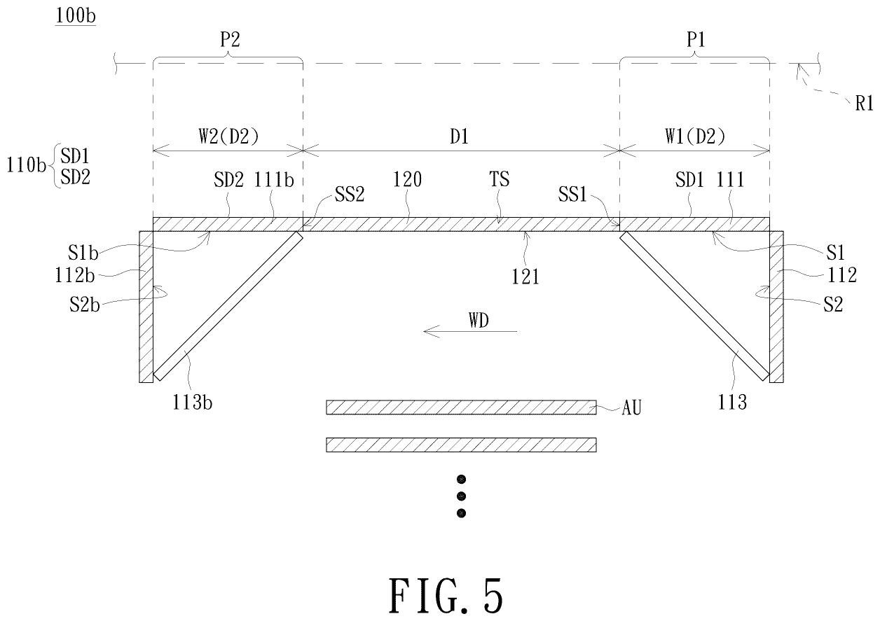

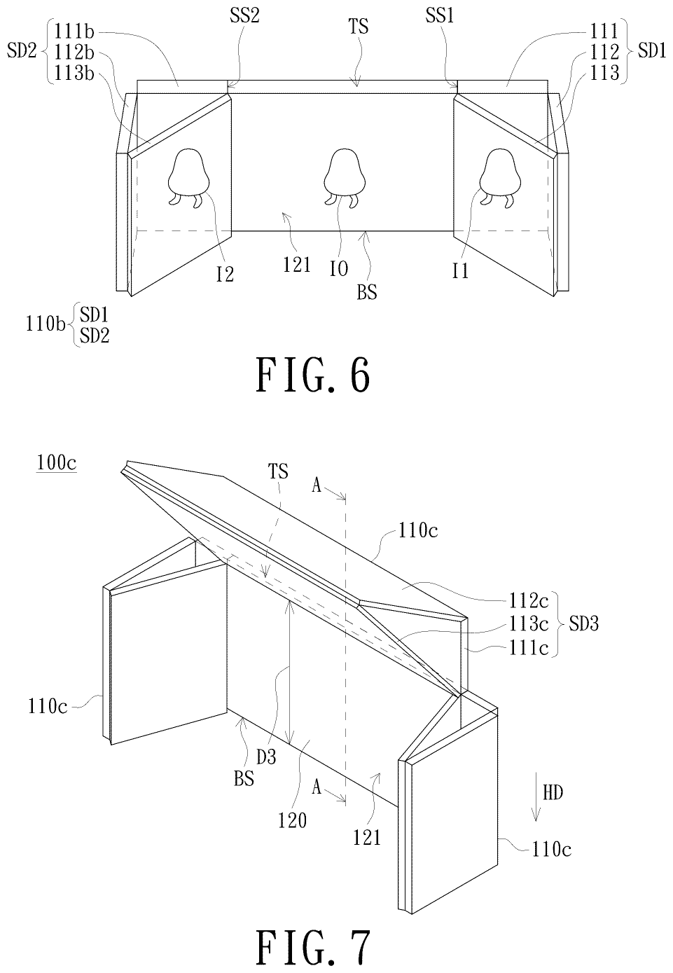

FIG. 5 is a top view schematic diagram of a three-dimensional display device in another embodiment of the present invention. FIG. 6 is a three-dimensional schematic diagram of the three-dimensional display device in FIG. 5. The structure and advantages of the three-dimensional display device 100b in the embodiment are similar to those in the embodiment shown in FIG. 2, and differences are merely described below. Referring to FIG. 5 and FIG. 6, the three-dimensional display device 100b can further include a central display panel 120. The central display panel 120 has a top surface TS and a bottom surface BS (marked in FIG. 6) opposite to the top surface TS, and the central display panel 120 further has a first side surface SS1 and a second side surface SS2 opposite to the first side surface SS1, wherein the first side surface SS1 and the second side surface SS2 are connected to and between the top surface TS and the bottom surface BS. The three-dimensional display assembly 110b includes a first three-dimensional display assembly SD1 and a second three-dimensional display assembly SD2, and the first display panels 111 of the first three-dimensional display assembly SD1 and the first display panels 111b of the second three-dimensional display assembly SD2 are respectively connected to the first side surface SS1 and the second side surface SS2. In other words, the first display panel 111 of the first three-dimensional display assembly SD1 is connected to the first side surface SS1, and the first display panel 111b of the second three-dimensional display assembly SD2 is connected to the second side surface SS2.

The central display panel 120 can serve as a main screen of the three-dimensional display device 100b, and the central display panel 120 is able to provide a two-dimensional image or a three-dimensional image according to different requirements. For example, the central display panel 120 in the embodiment can be a two-dimensional display panel, and the two-dimensional display panel can include a plane display panel or a curved display panel. Further, the central display panel 120 is, for example, a sub-millimeter light-emitting diode display panel in an embodiment. In addition, the central display panel 120 may be a polarizing type three-dimensional display panel in another embodiment.

The first three-dimensional display assembly SD1 and the second three-dimensional display assembly SD2 can be the three-dimensional display assembly 110a in FIG. 4 in the embodiment, and the features of the first display panel 111b, the second display panel 112b and the transparent display panel 113b are the same as those of the first display panel 111, the second display panel 112 and the transparent display panel 113 in FIG. 4. Therefore, related descriptions are omitted herein. However, the first three-dimensional display assembly SD1 and the second three-dimensional display assembly SD2 can also be configured as the three-dimensional display assembly 110 in FIG. 2 in other embodiments. The first three-dimensional display assembly SD1 and the second three-dimensional display assembly SD2 can serve as extended screens of the three-dimensional display device 100b in the embodiment,. For example, the three-dimensional display device 100b can be applied to a cinema, wherein an auditorium AU (drawn in FIG. 5) of the cinema can be arranged in front of the central display panel 120, i.e., the display surface 121 of the central display panel 120 faces to the auditorium AU, so that the first three-dimensional display assembly SD1 and the second three-dimensional display assembly SD2 are located on two opposite sides of the auditorium AU. Therefore, the audience is able to watch the display surface 121 from the auditorium AU at a direction approximately forward direction, and the audience is able to further watch the three-dimensional images I1 and I2 (drawn in FIG. 5) through facing to the transparent display panels 113 and 113b, so as to avoid distortion of the three-dimensional images I1 and I2 as a result of deviation of the watched angle, thereby further improving the visual effect provided by the three-dimensional display device 100b. It is to be understood that, the three-dimensional display device 100b can be applied to a home cinema in other embodiments, and which is not limited by the present invention.

Referring to FIG. 5 continuously, in the embodiment, a width of the central display panel 120 is D1 in a width direction WD pointed from the first side surface SS1 to the second side surface SS2. A reference plane R1 is parallel to a display surface 121, and a total width of orthogonal projections P1 and P2 of the first three-dimensional display assembly SD1 and the second three-dimensional display assembly SD2 on the reference plane R1 in the width direction is D2. D2 accounts for 8% to 25% of D1. In detail, a total width of the orthogonal projection P1 of the first display surface S1 and the second display surface S2 on the reference plane R1 is W1, a total width of the orthogonal projection P2 of the first display surface S1b and the second display surface S2b on the reference plane R1 is W2, and W1+W2=D2. In addition, W1 and W2 can be substantially equal to each other. D1 may be between 5 meters and 25 meters in an embodiment, and D2 may be between 4 meters and 6.25 meters in an embodiment, which are not limited by the present invention.

Referring to FIG. 6 again, incidentally, the three-dimensional images I1 and I2 generated by the first three-dimensional display assembly SD1 and the second three-dimensional display assembly SD2 is able to further enhance the visual effect provided by the three-dimensional display device 100b in the embodiment. For example, the central display panel 120 is able to generate a major image I0 moving in the screen, and the first three-dimensional display assembly SD1 is able to generate a three-dimensional image I1 moving to match with the movement of the major image I0, thereby improving the visual effect of the major image I0 moving from the first three-dimensional display assembly SD1 to the central display panel 120. Similarly, the second three-dimensional display assembly SD2 is able to generate a three-dimensional image I2 moving to match with the movement of the major image I0, thereby improving the visual effect of the major image I0 moving from the central display panel 120 to the second three-dimensional display assembly SD2.

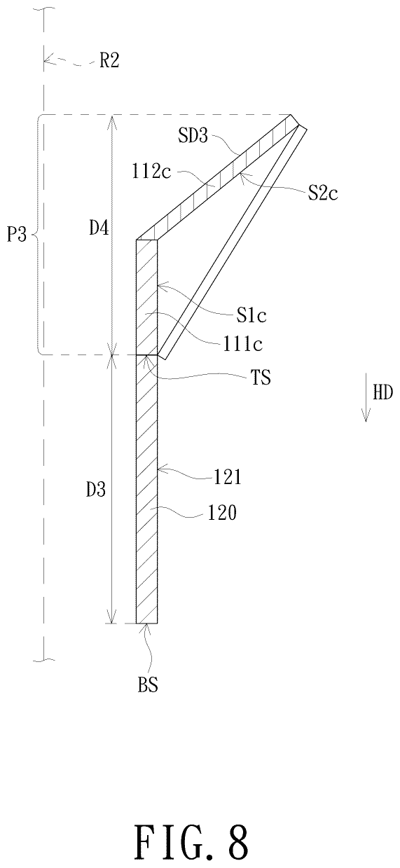

FIG. 7 is a three-dimensional schematic diagram of the three-dimensional display device in another embodiment of the present invention. FIG. 8 is a side view schematic diagram of a central display panel and a three-dimensional display assembly connected to a top surface in FIG. 7. The structure and advantages of the three-dimensional display device 100c in the embodiment are similar to those in the embodiment shown in FIG. 5, and differences are merely described below. Referring to FIG. 7 and FIG. 8, the three-dimensional display assembly 110c may further include a third three-dimensional display assembly SD3. The first display panel 111c of the third three-dimensional display assembly SD3 is connected to the top surface TS or the bottom surface BS, and the third three-dimensional display assembly SD3 is connected to the top surface TS as an example in the embodiment. Thus, the number of extended screens of the three-dimensional display device 100c can be further increased, thereby further improving the visual experience. Detailed characteristics of the third three-dimensional display assembly SD3 are the same as those of the first three-dimensional display assembly SD1 and the second three-dimensional display assembly SD2 in FIG. 5, so related descriptions are omitted herein. A height of the central display panel 120 is D3 in a height direction HD pointed from the top surface TS to the bottom surface BS. A reference plane R2 (drawn in FIG. 8) is parallel to the display surface 121 of the central display panel 120, a height of an orthogonal projection P3 of the third three-dimensional display assembly SD3 on the reference plane R2 in the height direction HD is D4. D4 accounts for 5% to 15% of D3. For example, the height D4 is, for example, a total height of the orthogonal projections P3 of first display surface S1c and the second display surface S2c of the second display panel 112c on the reference plane R2. D3 may be between 3 meters and 15 meters in an embodiment, and D4 may be between 0.15 meter and 2.25 meters in an embodiment. Specific numerical values are not limited by the present invention.

Incidentally, the third three-dimensional display assembly SD3 can be the three-dimensional display assembly 110 in FIG. 3 in the embodiment, and characteristics of the first display panel 111c, the second display panel 112c and the transparent display panel 113c are the same as those of the first display panel 111, the second display panel 112 and the transparent display panel 113 in FIG. 3. Therefore, related descriptions are omitted herein.

In summary, the three-dimensional display device provided by the present invention uses the first display panel and the second display panel spliced with each other, and the three-dimensional display device is further configured with the transparent display panel to shield the splicing beam between the first display panel and the second display panel. In detail, there is an included angle between the first display panel and the second display panel, so the first display panel and the second display panel are to generate a three-dimensional image as a main picture. In addition, the transparent display panel can generate an auxiliary picture to enhance the representation effect of the three-dimensional image, and the transparent display panel also can reduce the visual interference of the splicing beam to the audience by the secondary optical theory (such as refraction). Therefore, the three-dimensional display device of the present invention is able to provide a naked vision function and further has the following advantages of (1) improving the depth of field and a three-dimensional effect; (2) reducing the visual interference of the splicing beam to the audience; and (3) additionally representing subtitles or other auxiliary information by the transparent display panel. Based on above, the three-dimensional display device provided by the present invention can effectively improve the visual experience.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A three-dimensional display device, comprising:
at least one three-dimensional display assembly, each the three-dimensional display assembly comprising:
a first display panel, having a first display surface;
a second display panel, connected to a side of the first display panel, and the second display panel having a second display surface, an included angle being between the second display surface and the first display surface; and
a transparent display panel, forming a triangular prism with the first display panel and the second display panel, the first display surface and the second display surface facing to the transparent display panel.

2. The three-dimensional display device according to claim 1, wherein the included angle is between 75° and 150°.

3. The three-dimensional display device according to claim 1, wherein the included angle is between 90° and 120°.

4. The three-dimensional display device according to claim 1, further comprising a central display panel, the central display panel having a top surface and a bottom surface opposite to the top surface, and the central display panel further having a first side surface and a second side surface opposite to the first side surface, wherein the first side surface and the second side surface are connected to and between the top surface and the bottom surface, the at least one three-dimensional display assembly comprises a first three-dimensional display assembly and a second three-dimensional display assembly, the first display panel of the first three-dimensional display assembly and the first display panel of the second three-dimensional display assembly are respectively connected to the first side surface and the second side surface.

5. The three-dimensional display device according to claim 4, wherein a width of the central display panel is D1 in a width direction pointed to the second side surface from the first side surface, a reference plane is parallel to a display surface of the central display panel, and a total width of an orthogonal projection of the first three-dimensional display assembly and the second three-dimensional display assembly on the reference plane in the width direction is D2, D2 accounting for 8% to 25% of D1.

6. The three-dimensional display device according to claim 4, wherein the at least one three-dimensional display assembly further comprises a third three-dimensional display assembly, and the first display panel of the third three-dimensional display assembly is connected to the top surface or the bottom surface.

7. The three-dimensional display device according to claim 6, wherein a height of the central display panel is D3 in a height direction pointed to the bottom surface from the top surface, a reference plane is parallel to a display surface of the central display panel, and a height of an orthogonal projection of the third three-dimensional display assembly on the reference plane in the height direction is D4, D4 accounting for 5% to 15% of D3.

8. The three-dimensional display device according to claim 4, wherein the central display panel is a small pitch light-emitting diode display panel.

9. The three-dimensional display device according to claim 1, wherein the first display panel and the second display panel are sub-millimeter light-emitting diode display panels, the transparent display panel is a small pitch light-emitting diode display panel, a micro light-emitting diode display panel, an organic light-emitting diode display panel or a liquid crystal display panel.
